(19) United States
(12) Patent Application Publication
(10) Pub. No.: US 2005/0177556 A1
(43) Pub. Date: Aug. 11, 2005

(54) Systems and methods for transforming SQL syntax trees into relational algebra representations

(75) Inventors: Jun Fang, Sammamish, WA (US); Aakash Kambuj, Kirkland, WA (US); Evgueni Zabokritski, Redmond, WA (US); Honggang Zhang, Bellevue, WA (US); Peter Carlin, Seattle, WA (US)

Correspondence Address: WOODCOCK WASHBURN LLP, ONE LIBERTY PLACE - 46TH FLOOR, PHILADELPHIA, PA, 19103, US

(73) Assignee: MICROSOFT CORPORATION

(21) Appl. No.: 10/776,895

(22) Filed: Feb. 10, 2004

(51) Int. Cl. G06F 7/00

(52) U.S. Cl. 707/3

(57) ABSTRACT

The SQL Algebrizer of the present invention comprises a plurality of algorithms to “algebrize” SQL Trees to QP Algebra using an approach that is more consistent and much more efficient than typical algebrizers. More specifically, the Algebrizer of the present invention processes a SQL Tree using a reduced number of recursive depth-first passes by performing multiple operations in a single pass. Furthermore, the Algebrizer of the present invention also performs the operation of constant folding in this single, multi-operation pass so that the QP, upon receiving the QP Algebra, needs not perform this operation at all.

### FIELD OF THE INVENTION

The present invention generally relates to the field relational databases and, more specifically, to systems and methods pertaining to an “SQL Algebrizer” (or, more simply, and “Algebrizer”) for transforming SQL syntax tree representations (“SQL Tree”) of relational database queries (“SQL Text”) into relational algebra representations (“QP Algebra”).

### BACKGROUND OF THE INVENTION

Relational algebra is a formal mathematical notation that allows for expressing requests to relational databases in a strict and unambiguous way. Certain SQL server components (such as a query optimizer, for example) require the relational database requests be expressed in relational algebra and, more specifically, in QP Algebra (defined later herein).

Queries are made to a database in the form of SQL Text which, when parsed, is converted into a SQL Tree that must be transformed into QP Algebra for processing by as SQL Query Processor (“QP”). As known and appreciated by those of skill in the art, the task of transforming a SQL Tree to QP Algebra is performed by an algebrizer.

In general, an algebrizer determines if a relational database query—SQL Text that has been parsed/converted into a SQL Tree—is semantically correct and if so, transforms the SQL Tree into QP Algebra (a specific form of relational algebra understandable to a QP). One approach is for an algebrizer to process a SQL Tree recursively in a depth-first fashion by making one pass per “algebrizing” operation. However, while an algebrizer typically performs more than one distinct operation to “algebrize” a syntax tree representation of a relational database query into a relational algrebra representation, a typical algebrizer does not typically do any constant folding, which is an operation that is usually performed by the QP (and discussed in more detail later herein).

What is needed is an algebrizer that not only processes a SQL Tree using a reduced number of passes, but also one that performs constant folding so that it is no longer necessary for the QP to perform this task.

### SUMMARY OF THE INVENTION

The SQL Algebrizer of the present invention comprises a plurality of algorithms to “algebrize” SQL Trees to QP Algebra using an approach that is more consistent and much more efficient than typical algebrizers. More specifically, the Algebrizer of the present invention processes a SQL Tree using a reduced number of recursive depth-first passes by performing multiple operations in a single pass. Furthermore, the Algebrizer of the present invention also performs the operation of constant folding in this single, multi-operation pass so that the QP, upon receiving the QP Algebra, needs not perform this operation at all.

More specifically, the following steps are performed in a single pass through the SQL Tree for various embodiments of the present invention:
table and column binding: for every column name in the query, determining which table and column in the database it refers to;
aggregate binding: for every aggregate function, determining which query specification it should be computed;
type derivation: for every scalar expression in the query, determining the type of the expression;
constant folding: if a scalar expression is constant (does not depend on the data in the database), determining the value of the expression (which is normally a step undertaken by the QP, not an algebrizer);
property derivation: determining whether the statement being processed is deterministic, precise, accesses database data, and other properties of the statement that are necessary for the correct execution of the statement; and
tree translation: where the resultant in-process SQL Tree node—enhanced and modified by the previous steps—is translated directly into QP Algebra.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram representing a computer system in which aspects of the present invention may be incorporated;

FIG. 2 shows an exemplary table from a relational database (e.g., a SQL database);

FIG. 3A shows an example of the Cartesian product of two tables;

FIG. 3B FIG. 3B shows an example of a join of two tables;

FIG. 4 is a block diagram illustrating a system for transforming SQL Text into input for the QP; and

FIG. 5 is a block diagram illustrating one embodiment of the present invention for efficiently and more completely transforming SQL Text into input for the QP.

### DETAILED DESCRIPTION OF ILLUSTRATIVE EMBODIMENTS

The inventive subject matter is described with specificity to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Computer Environment

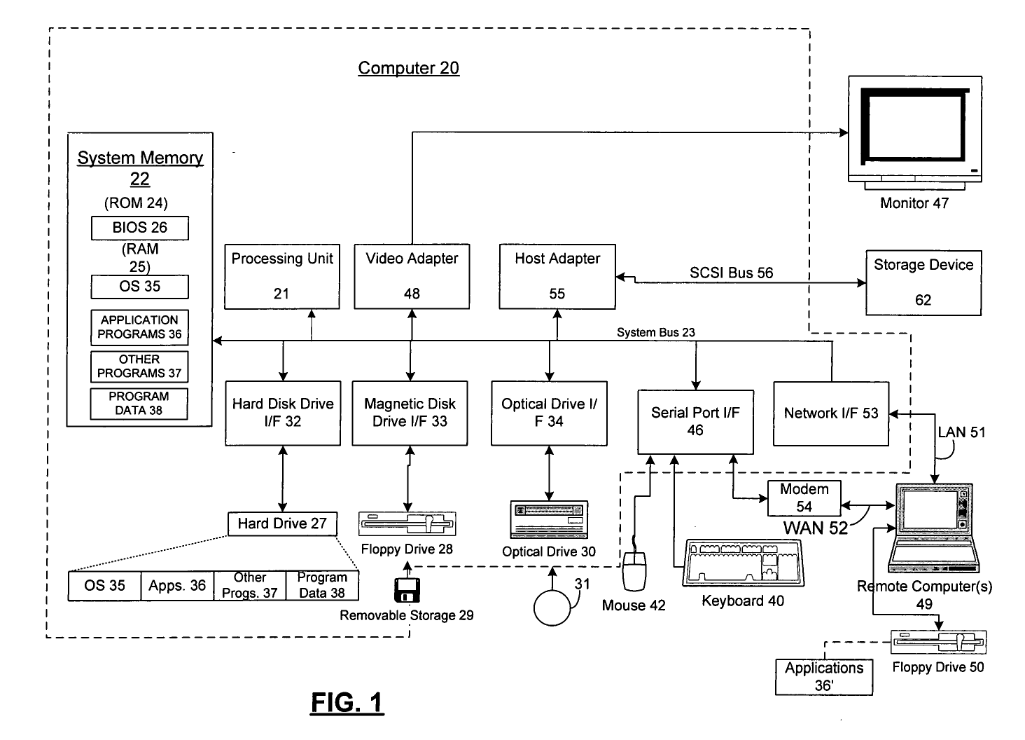

Numerous embodiments of the present invention may execute on a computer. FIG. 1 and the following discussion is intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand held devices, multi processor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used. Moreover, while it is envisioned that numerous embodiments of the present invention are particularly well-suited for computerized systems, nothing in this document is intended to limit the invention to such embodiments.

Relational Databases

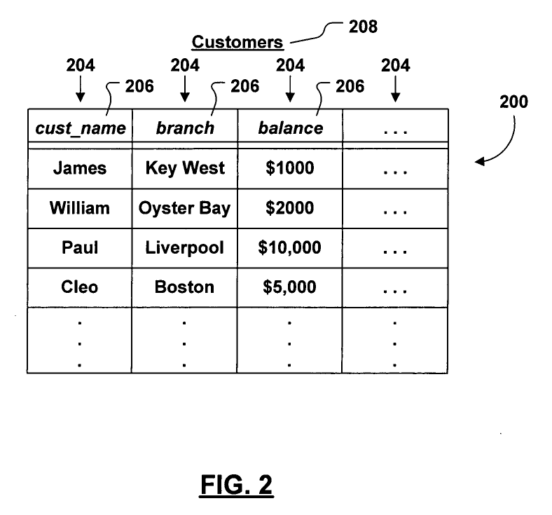

Many modern database systems, and specifically those based on the relational model, store data in the form of tables. A table is a collection of data organized into rows and columns. FIG. 2 shows an exemplary table 200. In this example, table 200 is a list of bank customers, showing each customer's branch and balance. Table 200 has rows 202 and columns 204. Each column 204 has a name 206. Table 200 may also have a name 208. In the example of FIG. 2, table 200 has the name 208 “Customers.” Table 200 has three columns 204. The names 206 of columns 204 are “cust_name,” “branch,” and “balance,” respectively. The first row 202 of table 200 contains the data “James,” “Key West,” and “$1000.” In the terminology of database systems, table 200 is sometimes referred to as a “relation,” each row 202 as a “tuple,” and the name 206 of each column as an “attribute.” It will be appreciated that the depiction of table 200 in FIG. 2 is merely exemplary. A table may have any number of rows and columns, and may store any type of data, without departing from the spirit and scope of the invention.

Relational algebra is a formal mathematical notation that allows for expressing requests to relational databases in a strict and unambiguous way. Certain SQL server components (such as a query optimizer, for example) may require the relational database requests be expressed in relational algebra.

Relational algebra comprises a plurality of operations that can be performed on tables and, for example, includes a set of operators that take one or more tables as operands and produce a new table as a result. One important operation in the relational algebra is the “Cartesian product.” Cartesian product is a binary operation that takes two tables as operands and produces a third table as a result. The Cartesian product of two tables R and S (written as R×S) is formed by pairing each row of R with all the rows of S.

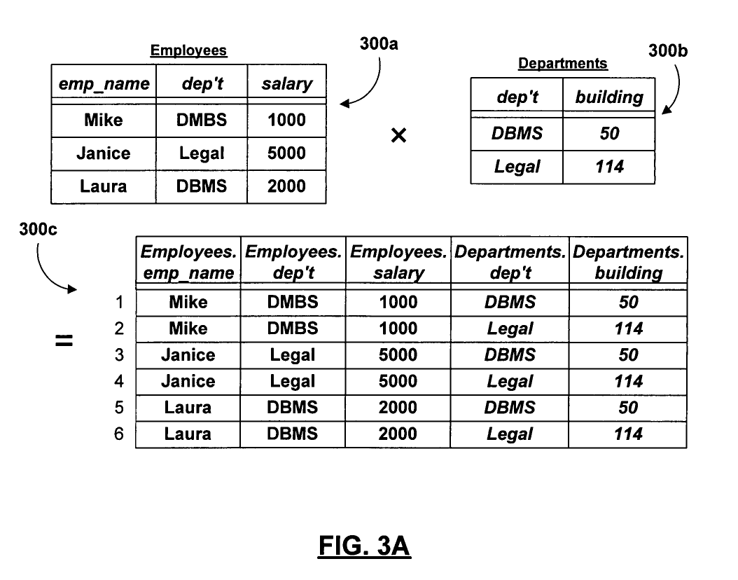

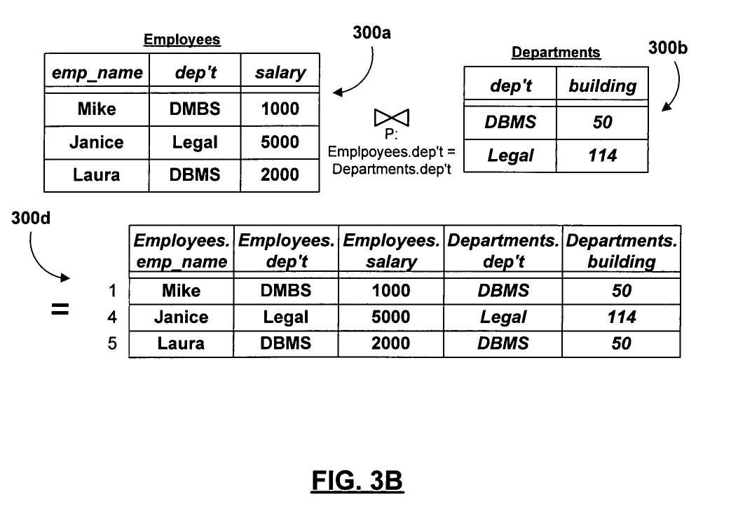

FIG. 3A shows an example of the Cartesian product of table 300a and 300b. Table 300a has three columns (“emp_name,” “dep't,” and “salary”), and table 300b has two columns (“dep't” and “bldg”). The Cartesian product of tables 300a and 300b is a third table 300c having five columns. It will be observed that the five columns of table 300c are the three columns of table 300a plus the two columns of table 300b. (In FIG. 3A, the name of each column in the product table indicates the name of the table from which that column originated. Thus, the first column is named “Employees.emp_name,” the second column “Employees.dep't,” etc.) Each row of table 300c is formed by taking a row of table 300a and pairing it with all of the rows of table 300b. Thus, the first row of table 300c is formed by concatenating the first row of table 300a with the first row of table 300b. The second row of table 300c is formed by concatenating the first row of table 300a with the second row of table 300b. After the rows of table 300b have been exhausted, the next row of table 300a is paired with each row of table 300b to produce the third and fourth rows of table 300c. The process is repeated for each row of table 300a until all the rows of table 300a have been exhausted. It will be appreciated that if table R has R_{R} rows and R_{C} columns, and table S has S_{R} rows and S_{C} columns, then the Cartesian product R×S is a table having R_{R} S_{R} rows and R_{C}+S_{C} columns.

Usually the information sought from a database system is not the entire Cartesian product of two tables, but rather selected rows of the Cartesian product. In this case, a “join” of the two tables may be performed. A join is the Cartesian product of two tables, where particular rows of the resulting Cartesian product are selected according to a predicate. Specifically, the join of two tables R [symbol] ₚS is those rows of R×S that satisfy the predicate P.

FIG. 3B shows an example of a join. Specifically, table 200d is the table that results from performing a join on tables 200a and 200b, where the predicate P is “Employees.dep't=Department.dep't.” As discussed above, FIG. 3A shows the Cartesian product 200c of tables 200a and 200b. Thus, the join of tables 200a and 200b using the predicate P consists of all of the rows of table 200c that meet the condition “Employees.dep't=Dep't.dept.” A row meets the predicate P if the value of Employees.dep't for that row is equal to the value of Dep't.dept for that same row. As shown in FIG. 3B, this condition is met by rows 1, 4 and 5 of table 200c, and thus table 200d consists of those three rows of table 200c. Rows 2, 3, and 6 of table 200c have different values in the Employees.dep't and Department.dep't columns; thus, rows 2, 3, and 6 do not meet the predicate P and are not included in the result of R [symbol] ₚS.

The join operation demonstrated in FIG. 3B is a particular type of join called an “inner join.” It will be recognized by those of skill in the art that there are various types of joins, of which the inner join is a non-limiting example. Other types of join operations include the “semijoin” and the “anti-semijoin.” The semijoin of tables R and S (written R [symbol] S) is the table consisting of all rows of table R that agree with at least one row of table S for all columns that R and S have in common. The anti-semijoin of tables R and S (written R [symbol] S) is the table consisting of all rows of table R that do not agree with any row of table S for those columns that R and S have in common. When tables R and S have the same set of columns (i.e., each column in R has a corresponding column in S with the same column name, and vice versa), then R [symbol] S is the table consisting of all rows in R that appear in S, and R [symbol] S is the table consisting of all rows in R that do not appear in S. Semijoin and anti-semijoin can be further generalized by adding a predicate P. Thus, R [symbol] ₚS consists of those rows of R that agree with any row of S that satisfies the predicate P, and R [symbol] ₚS consists of those rows of R that do not agree with any row of S that satisfies the predicate P.

For general information on relational databases, see J. D. Ullman, Principles of Database and Knowledge-Base Systems, vol. 1 (W. H. Freeman & Co., 1988).

Typical Algebrizing

In general, a typical algebrizer receives a syntax tree (hereinafter, a “SQL Tree”) from the parser, checks and transforms the tree in a series of steps, and then generates (via “tree translation”) a QP Algebra tree as its output. (QP Algebra is a specific form of relational algebra in tree form understandable by a SQL Query Processor or “QP”.) An algebrizer is necessary because the input syntax tree (the SQL Tree) not only lacks many adornments (such as type information) that are expected by the Query Processor, but the SQL Tree also utilizes certain operators that are not understandable by (nor intended for) the QP (e.g., operators that are specific to the algebrizer). A typical algebrizer operates by making several distinct passes through the SQL Tree where each such pass walks the entire statement tree in a depth-first fashion.

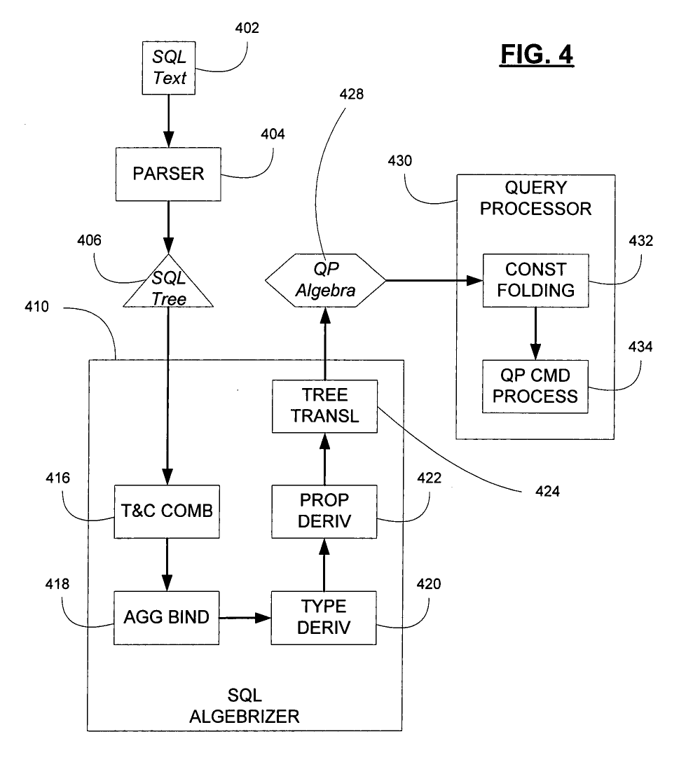

FIG. 4 is a block diagram illustrating a system for transforming SQL Text into input for the QP. SQL Text 402 is inputted into a Parser 404 that converts said SQL Text 402 into a SQL Tree 406 as output. This SQL Tree 406 is then inputted into the SQL Algebrizer 410. During a series of recursive depth-first passes through the SQL Tree—one pass per step—the Algebrizer 410 performs the following steps: Table and Column Combining 416; Aggregate Binding 418; Type Derivation 420; Property Derivation 422; and Tree Translation 424. After the step of Tree Translation 424 produces the QP Algebra 428 as output, this QP Algebra 428 is then inputted into the Query Processor 430 where the QP 430 first performs a step of Constant Folding 432 before proceeding with the QP Command Processing 434.

Table and Column Combining 416 is where every table and column name in the query is decorated with a reference to the corresponding column definition object (CValRef), and names representing the same object get the same reference. In this manner, the names themselves can be replaced with identical ValRef pointers when forming the QP Algebra (reflecting an optimized tree structure). The column definition objects are then initialized from the catalogs, and a check is made to ensure that every name in the query actually refers to a valid table or column that exists in the system catalogs and is visible within the particular query scope.

Aggregate Binding 418 is a necessary step because, in QP Algebra, an aggregate may only be a child of a GbAgg relational operator, whereas in SQL (e.g., SQL Text) aggregates are freely used in many contexts where a scalar expression is allowed. GbAgg operators, on the other hand, correspond to QuerySpecs in the input tree. Consider the following example:
SELECT c1 FROM t1 GROUP BY c1 HAVING EXISTS (SELECT*FROM t2 WHERE t2.x>MAX(t1.c2))
In this example, the MAX aggregate is in fact computed in the outer QuerySpec, although it is syntactically located in the inner one. However, in SQL, there is no explicit notion for this—the decision is made implicitly based on the aggregate's argument. Consequently, every aggregate needs to be bound to its hosting QuerySpec in QP Algebra, and the process of doing so is what is referred to herein as “aggregate binding” is the process undertaken by the step of Aggregate Binding 418.

Type Derivation 420 is the step where the types of any scalar nodes and full metadata for all relational nodes are determined, a necessary step since TSQL is statically typed. (TSQL, a.k.a. “Transact-SQL,” is a set of programming extensions that add several features to the SQL including transaction control, exception and error handling, row processing, and declared variables.) This step is done in a bottom-up fashion, starting from leaf nodes: columns (whose type information is read from the catalogs) and constants. Then, for non-leaf nodes, the type information is derived based on the particular node type and the types of its children nodes.

Property Derivation 422 is where the Algebrizer 410 determines whether the individual statements being processed are deterministic (that is, where repeated executions always net the same resultant value), precise (that is, where the same execution of a processor-influenced operation, e.g., the precision of a floating-point operation, nets the same resultant value on different processors), accesses database data (as opposed to, e.g., processing only scalar values), and other properties of the statement that are necessary for the correct and maximally efficient execution of the statement. The final step for the Algebrizer 410 is Tree Translation 424, where the resultant in-process SQL Tree—enhanced and modified by the previous steps—is finally translated directly into QP Algebra.

To complete each of the aforementioned steps, the typical algebrizer of FIG. XX requires six passes through the SQL Tree. However, none of these passes include a step of Constant Folding 432 which, as illustrated in FIG. 4, is performed by the QP 430 before undertaking the step of QP Command Processing 434.

Constant Folding 432 is a process whereby queries are simplified by removing statements that inevitably resolve to a scalar value. For example, consider the following SQL statement:
SELECT c1 FROM t WHERE c1>3 AND (SIN(30)*SIN(30)+COS(30)*COS(30)=1)
In this example, it is clear to see that the subpart of the second condition of the AND statement, “sin²(30)+cos²(30)=1”, always returns a value of “TRUE” because sin²(x)+cos²(x)=1, and thus this second condition can be reduced to the single value of “TRUE.” Further, since the result of an AND statement is “TRUE” if either condition is “TRUE,” and since the second condition is always “TRUE,” the AND statement itself is also always “TRUE.” Thus, the original example statement can be rewritten as follows:
SELECT c1 FROM t WHERE c1>3
In this regard, Constant Folding 432 is the process that identifies and replaces (“folds”) these kinds of scalar values (“constants”).
Improved Algebrizer

The SQL Algebrizer of the present invention comprises a plurality of algorithms to “algebrize” SQL Trees to QP Algebra using an approach that is more consistent and much more efficient than typical algebrizers. More specifically, the Algebrizer of the present invention processes a SQL Tree using a reduced number of recursive depth-first passes by performing multiple operations in a single pass. Furthermore, the Algebrizer of the present invention also performs the operation of constant folding in this single, multi-operation pass so that the QP, upon receiving the QP Algebra, needs not perform this operation at all.

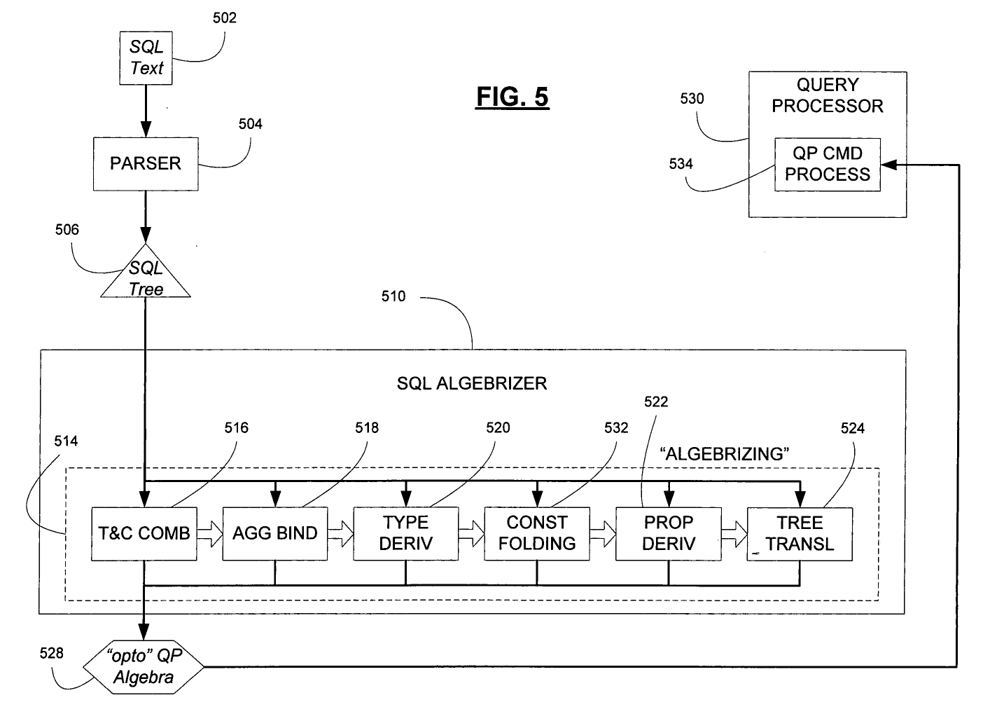

FIG. 5 is a block diagram illustrating one embodiment of the present invention for efficiently and more completely transforming SQL Text into input for the QP. SQL Text 502 is inputted into a Parser 504 that converts said SQL Text 502 into a SQL Tree 506 as output. This SQL Tree 506 is then inputted into the SQL Algebrizer 510. Then, in a single “Algebrizing” pass 514, the Algebrizer 510 performs the following operations sequentially at each node of the SQL Tree 506: Table and Column Combining 516; Aggregate Binding 518; Type Derivation 520; Constant Folding 232 (heretofore not performed in the Algebrizer); Property Derivation 522; and Tree Translation 524. The net result of this single Algebrizer Pass 5214 is Optimized QP Algebra 528 (optimized in the sense that this QP Algebra has already undergone the step of Constant Folding 5232) which is then inputted into the Query Processor 530 for immediate processing by the QP Command Process 534.

Conclusion

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the indexing functionality of the present invention.

While the present invention has been described in connection with the preferred embodiments of the various figures, it is to be understood that other similar embodiments may be used or modifications and additions may be made to the described embodiment for performing the same function of the present invention without deviating there from. For example, while exemplary embodiments of the invention are described in the context of digital devices emulating the functionality of personal computers, one skilled in the art will recognize that the present invention is not limited to such digital devices, as described in the present application may apply to any number of existing or emerging computing devices or environments, such as a gaming console, handheld computer, portable computer, etc. whether wired or wireless, and may be applied to any number of such computing devices connected via a communications network, and interacting across the network. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

Finally, the disclosed embodiments described herein may be adapted for use in other processor architectures, computer-based systems, or system virtualizations, and such embodiments are expressly anticipated by the disclosures made herein and, thus, the present invention should not be limited to specific embodiments described herein but instead construed most broadly. Likewise, the use of synthetic instructions for purposes other than processor virtualization are also anticipated by the disclosures made herein, and any such utilization of synthetic instructions in contexts other than processor virtualization should be most broadly read into the disclosures made herein.

1. A method for algebrizing a syntax tree representation of a relational database query into a relational algebra representation, said syntax tree comprising a plurality of nodes, and said algebrizing comprising a plurality of operations each of which can be performed in a single pass through said syntax tree representation, said method comprising the step of performing at least two operations in a single pass through said syntax tree representation.

2. The method of claim 1 wherein said at least two operations are executed in a predetermined order at each of said plurality of nodes.

3. The method of claim 2 wherein
said at least two operations comprise a first operation and a second operation; and
said second operation either executes or does not execute at each of said plurality of nodes and after said first operation based on a result from said first operation.

4. The method of claim 1 wherein said at least two operations comprises at least one operation from among a group of operations, said group of operations comprising: table and column binding; aggregate binding; type derivation; constant folding; property derivation; and tree translation.

5. The method of claim 1 wherein said at least two operations comprises at least all operations from among a group of operations, said group of operations comprising: table and column binding; aggregate binding; type derivation; property derivation; and tree translation.

6. The method of claim 5 wherein said group of operations further comprises constant folding.

7. The method of claim 1 wherein said algebrizing comprises at least one operation from among a group of operations, said group of operations comprising: table and column binding; aggregate binding; type derivation; constant folding; property derivation; and tree translation.

8. The method of claim 7 wherein said group of operations further comprises constant folding.

9. The method of claim 1 wherein said algebrizing comprises constant folding.

10. A method for algebrizing a syntax tree representation of a relational database query into a relational algebra representation, said syntax tree comprising a plurality of nodes, and said algebrizing comprising a plurality of operations, said method comprising the inclusion of constant folding as an operation among said plurality of operations.

11. A system for algebrizing a syntax tree representation of a relational database query into a relational algebra representation, said syntax tree comprising a plurality of nodes, said system comprising:
a plurality of operations; and
a subsystem for performing at least two operations in a single pass through said syntax tree representation.

12. The system of claim 11 wherein said system executes at least two operations in a predetermined order at each of said plurality of nodes during said single pass through said syntax tree representation.

13. The system of claim 12 wherein
said at least two operations comprise a first operation and a second operation;
said subsystem executes said first operation before said second operation at each of said plurality of nodes, and receives a result from said first operation at each of said plurality of nodes; and
said subsystem either executes or does not execute said second operation at each of said plurality of nodes, on a node by node basis, based on a result from said first operation.

14. The system of claim 11 wherein said at least two operations comprises at least one operation from among a group of operations, said group of operations comprising: table and column binding; aggregate binding; type derivation; constant folding; property derivation; and tree translation.

15. The system of claim 11 wherein said at least two operations comprises at least all operations from among a group of operations, said group of operations comprising: table and column binding; aggregate binding; type derivation; property derivation; and tree translation.

16. The system of claim 15 wherein said group of operations further comprises constant folding.

17. The system of claim 11 wherein said algebrizing comprises at least one operation from among a group of operations, said group of operations comprising: table and column binding; aggregate binding; type derivation; constant folding; property derivation; and tree translation.

18. The system of claim 17 wherein said group of operations further comprises constant folding.

19. The system of claim 11 wherein said algebrizing comprises constant folding.

20. A system for algebrizing a syntax tree representation of a relational database query into a relational algebra representation, said syntax tree comprising a plurality of nodes, said system comprising:
a plurality of operations; and
constant folding as an operation among said plurality of operations.

21. A computer-readable medium comprising computer-readable instructions for algebrizing a syntax tree representation of a relational database query into a relational algebra representation, said syntax tree comprising a plurality of nodes, and said algebrizing comprising a plurality of operations each of which can be performed in a single pass through said syntax tree representation, said computer-readable instructions comprising instructions for performing at least two operations in a single pass through said syntax tree representation.

22. The computer-readable instructions of claim 1 further comprising instructions for at least two operations to be executed in a predetermined order at each of said plurality of nodes.

23. The computer-readable instructions of claim 2 further comprising instructions for
at least two operations to comprise a first operation and a second operation; and
executing or not executing said second operation at each of said plurality of nodes after said first operation has executed based on a result from said first operation.

24. The computer-readable instructions of claim 1 further comprising instructions whereby said at least two operations comprise at least one operation from among a group of operations, said group of operations comprising: table and column binding; aggregate binding; type derivation; constant folding; property derivation; and tree translation.

25. The computer-readable instructions of claim 1 further comprising instructions whereby said at least two operations comprises at least all operations from among a group of operations, said group of operations comprising: table and column binding; aggregate binding; type derivation; property derivation; and tree translation.

26. The computer-readable instructions of claim 5 further comprising instructions whereby said group of operations further comprises constant folding.

27. The computer-readable instructions of claim 1 further comprising instructions whereby said algebrizing comprises at least one operation from among a group of operations, said group of operations comprising: table and column binding; aggregate binding; type derivation; constant folding; property derivation; and tree translation.

28. The computer-readable instructions of claim 7 further comprising instructions whereby said group of operations further comprises constant folding.

29. The computer-readable instructions of claim 1 further comprising instructions whereby said algebrizing comprises constant folding.

30. A computer-readable medium comprising computer-readable instructions for algebrizing a syntax tree representation of a relational database query into a relational algebra representation, said syntax tree comprising a plurality of nodes, and said algebrizing comprising a plurality of operations, said computer-readable instructions comprising instructions for constant folding as an operation among said plurality of operations.
